(19) United States
(12) Patent Application Publication
(10) Pub. No.: US 2016/0217712 A1
(43) Pub. Date: Jul. 28, 2016

(54) METHODS FOR IMPROVING SECUREMENT OF LABELS TO CONTAINERS

(71) Applicant: PEPSICO, INC., Purchase, NY (US)

(72) Inventors: James A. Stevenson, Pittsburgh, PA (US); Charles White, Purchase, NY (US)

(21) Appl. No.: 14/906,877

(22) PCT Filed: Jul. 22, 2014
(86) PCT No.: PCT/US2014/047660

§ 371 Date: Jan. 21, 2016

Related U.S. Application Data
(60) Provisional application No. 61/856,942, filed on Jul. 22, 2013.

(51) Int. Cl. G09F 3/02; B65D 23/14; G09F 3/10

(52) U.S. Cl. CPC G09F 3/02; G09F 3/10; B65D 23/14; G09F 2003/0272; G09F 2003/0257

(57) ABSTRACT

A method of forming a label for a container is provided. The method comprises extruding at least one layer to form the label, increasing the surface energy of the label, and securing the label to a container with an adhesive. The texture can be formed onto the label by embossing, chemically etching or exposing the label material to UV radiation. The texture helps improve the adhesion of the label to the container. In another example, the label can be provided with a primer or an EVA heat seal coating to improve the adhesion of the label to a container.

### CROSS REFERENCE TO RELATED APPLICATION

This application claims priority to U.S. Application No. 61/856,942, filed on Jul. 22, 2013, which is fully incorporated by reference herein.

### FIELD

The disclosure herein generally relates to methods of securing labels to containers and maintaining labels on containers during the usage life of the containers.

### BACKGROUND

Containers in the form of bottles are used to contain beverages such as soft drinks, juices, sports drinks, alcoholic beverages, as well as other types of materials that may be in liquid, solid or powder form. These containers typically include decorative or informative labels or graphics to identify, for example, the beverage, the producer of the beverage, or information concerning the beverage. These labels are also used to provide an aesthetically pleasing look to the container to enhance the beverage's appeal to consumers.

The strength of adhesion between a label and an outside surface of a container is of considerable interest to adhesive manufacturers, bottling plants, marketers, compliance officers, and the like. For example, weak adhesion between the label and the outside surface of the container and/or the outer surface of the label and the inner surface of the overlap portion of the label may lead to the label working loose (and in some cases even separating from the container completely) during shipping or storing the container. Such a weak bond may thus lead to a product that is not attractive to consumers (e.g., a container with a unfastened label) or a product that does not conform to labeling requirements (e.g., Food and Drug Administration (FDA) regulations).

In some instances, transporting and/or storing a labeled container may present conditions that expedite adhesive failure. For example, labeled containers are often subjected to heightened temperatures and/or high humidity during transportation and storage prior to being delivered to retailers. In addition to decreasing the effectiveness of the adhesive, this heightened temperature and/or humidity may cause the container and its contents to expand and place increased stresses on the bond, further accelerating adhesive failure. For example, the containers may be subjected to refrigeration and/or storage in ice water, exposed to room temperature, and then refrigerated again. The temperature changes going from cold to hot to cold again may accelerate the failure of the adhesive.

Labels have been applied to containers using various techniques. For example, clear labels can be applied to containers through the use of an adhesive. However, the adhesive connection of clear labels to containers may be difficult to maintain over the usage life of the container and the label may fall off of the container during the use of the container. Certain labels such as opaque labels secure more readily than clear labels. In addition, certain labels, such as carbonated soft drink container labels, are subjected to flagging failures or peeling over time during transportation and storage of the containers. In certain instances, the label may peel off from the container near a portion of the label that overlaps, or the failure may occur between the adhesive and the surface of the label. These failures may result from the container expanding in the presence of increased temperatures or during the handling of the containers.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

In one example, a method of forming a label for a container is discussed. The method can include extruding at least one layer of material to form the label, forming a texture onto the label, and securing the label to a container with an adhesive. The texture can be formed onto the label by embossing or chemically etching. The texturing on the label helps improve the adhesion of the label to the container. In another example, the label material can be exposed to UV radiation to provide for a better bond between the label and the container and a better bond between the label itself at the overlap portion of the label once the adhesive is applied to the label. In another example, the label can be provided with an EVA heat seal to improve the adhesion of the label to a container.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1A illustrates an isometric view of a container with an exemplary label.

FIG. 1B illustrates a cross-sectional view of the container and the label of FIG. 1A along line 1B in FIG. 1A.

FIG. 2A depicts the inner surface of the label, which adheres to the container.

FIG. 2B depicts the outer surface of the label, which is displayed on the container.

FIG. 3 illustrates the label as being applied to a container surface.

FIG. 4 illustrates an exemplary label sheet formation process where the label sheet is embossed.

FIG. 5 illustrates an exemplary label sheet formation process where the label sheet is chemically etched.

FIG. 6 illustrates an exemplary label sheet formation process where the label sheet is provided with a primer.

FIG. 7 illustrates an exemplary label sheet formation process where the label sheet is provided with a mineral material that is incorporated into the polymer matrix.

FIG. 8 depicts an example container to which a label can be applied using the example methods discussed herein.

FIG. 9 depicts another example container to which a label can be applied using the example methods discussed herein.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention. The invention is capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

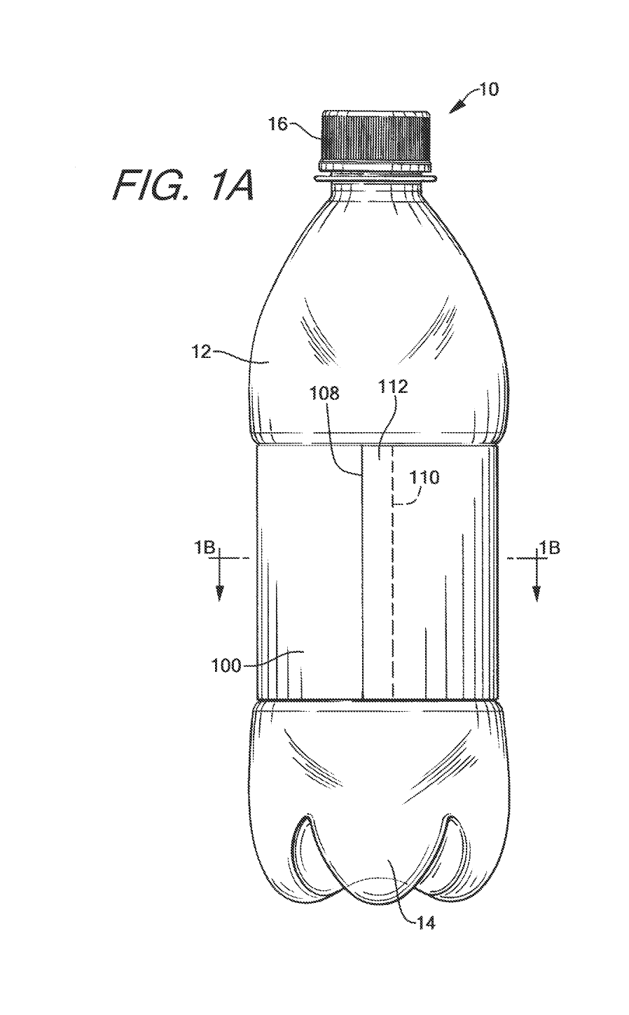

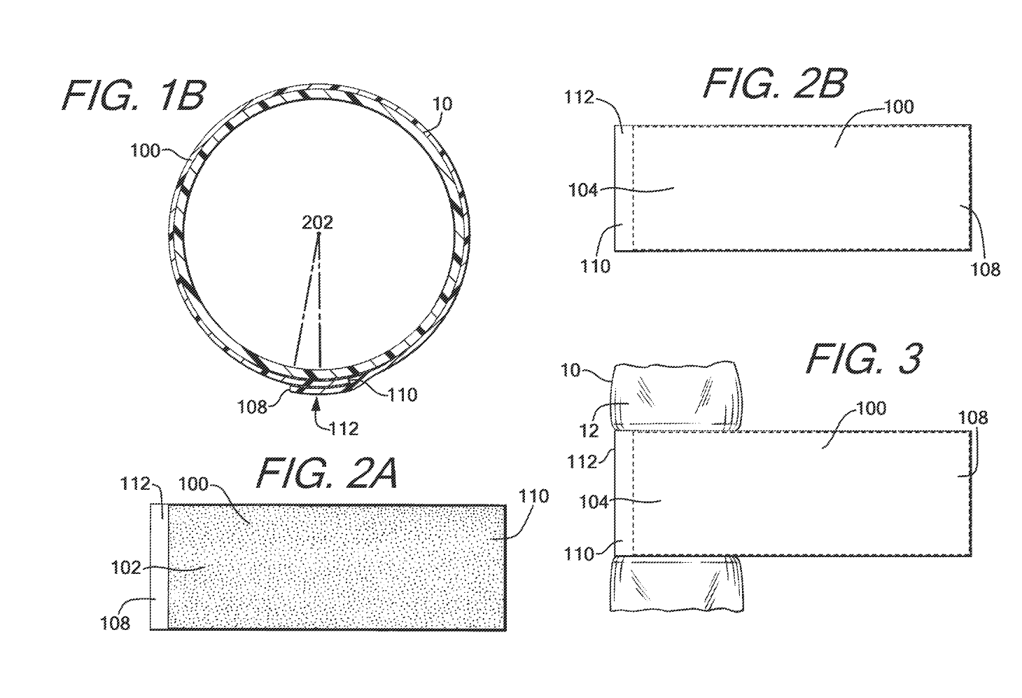

FIG. 1A illustrates a container 10 which may be used in connection with one or more examples of the disclosure. Container 10 comprises a generally elongated plastic outer surface 12 comprising a cap 16 removably attachable to a top portion of the container 10 to enclose, e.g., a consumable liquid contained therein, and a base structure 14 configured to, e.g., support the container 10 in an upright position when placed on a surface. The container 10 may be constructed of any well-known material in the art, and, in some embodiments, the container 10 may be made of polyethylene terephthalate (“PET”) or other suitable material. The container 10 may further include a label 100, which can be in the form of a strip that can be adhered to the outer surface 12. In some examples, the label 100 may be formed generally rectangular in shape and wrapped around the outer surface 12 of container 10.

In the example shown in FIG. 1A, the label 100 can be applied to a middle cylindrically-shaped section of the container 10. The label 100 can include various information which may include a product name, a logo, nutrition facts, universal product code (UPC), Quick Response Code (QR code), sponsorship information, recycling information, volume information, and other relevant product information for the consumer. In one example, the label 100 can be formed of polyethylene, polypropylene, or combinations thereof. However, other suitable materials are also contemplated. The label 100 can be formed in an extrusion operation or in a layered extrusion operation if it is to be formed of more than one material. An adhesive can be applied to an inside surface of the label 100 for securing the label 100 to the container 10.

In one example with reference to FIGS. 1A and 1B, the label 100 may comprise a first portion 108 which overlaps a second portion 110. The first and second portions 108, 110 of the label 100 may be adhered to each other using any desirable adhesive 202 to form an overlap or seal 112. In particular, the seal 112 is formed where the first portion 108 of label 100 overlaps and is adhered to the second portion 110 of label 100. The seal 112 may help provide a better securement of the label 100 to the container 10. Further, the adhesive 202 may be used to adhere any or all portions of the label 100 to the outer surface 12 of container 10. Thus, the label 100 may be adhered to itself or the container 10 at one or more locations around the circumference of container 10. As depicted in FIG. 1B, adhesive 202 is applied between the label 100 and the outer surface 12 of container 10 near seal 112, and between the first and second portions 108, 110 of the label 100 at seal 112.

FIG. 2A depicts a front view of the label 100, and FIG. 2B depicts a rear view of the label. As shown in FIGS. 2A and 2B, the label 100 includes a first inner surface 102 for receiving the adhesive 202 to adhere the label 100 to the container 10, and a second outer surface 104 for displaying the graphics and the product information the label 100 on the container 10. FIG. 3 shows an example of how the label 100 can be wrapped around and secured to the container 10.

Embossing Label Film to Enhance Adhesion

In one example, the film forming the label can be embossed or provided with a texture or texturing to improve the adhesive properties of the label. During the embossing process, both the first inner surface 102 and the second outer surface 104 can be provided with texturing. The texturing can be provided to the label through the use of embossing rolls, for example; however, other known methods are also contemplated. In this way, the material forming the label can be passed through at least one pair of embossing rolls to provide the texture onto the first surface 102 and the second surface 104 of the label 100. The rolls can be provided with a predetermined pattern, which can be imprinted onto the label. Various patterns are contemplated for embossing the label including dimpled, x-shaped, circular, diamond, square, rhombus shaped, etc. In this example, the texturing can be provided to both the first surface 102 and the second surface 104 of the label 100. However, it is contemplated that the texturing can be provided to only selected or critical portions of the label such as the first and second portions 108, 110 to improve the adhesion properties of the label 100.

By embossing the film forming the label, adhesion should be promoted as rougher surfaces tend to improve adhesion and thereby increasing the surface energy of the film. In particular, texturing aids in increasing the surface energy by providing pockets or areas for the adhesive to fill into, which in turn allows for additional adhesive to be provided on the label. These areas increase the wettability and surface energy of the label and can help improve the securing of the label to the container.

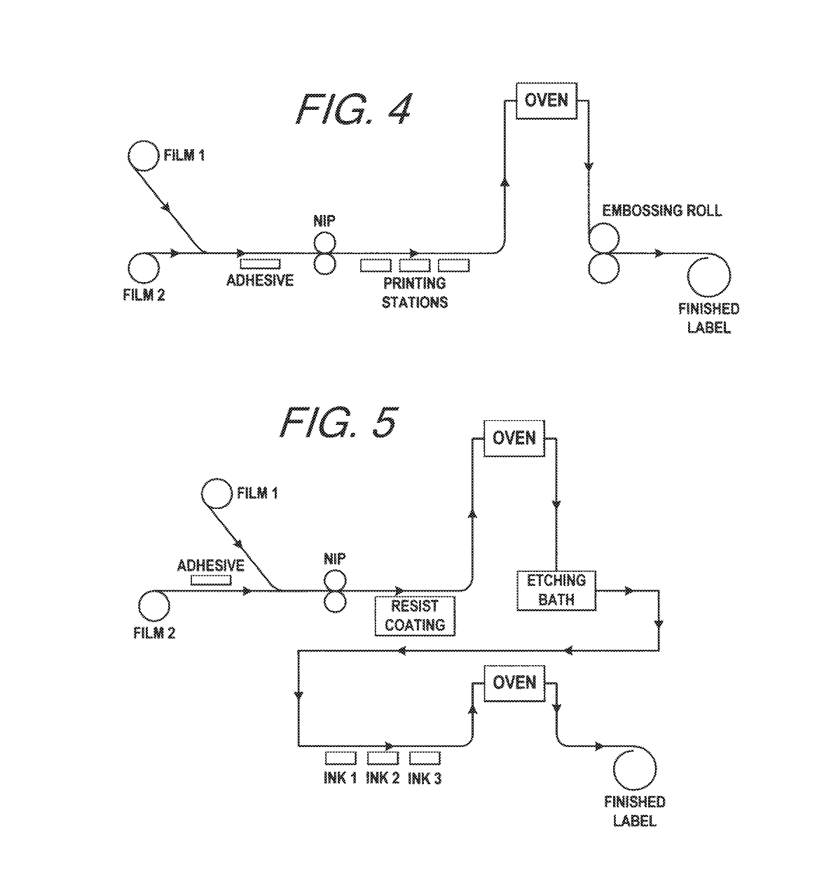

An exemplary embossing process will now be described in relation to FIG. 4. First the label can be formed using a first film and a second film in a lamination operation. To laminate the first film and the second film, an adhesive can be applied to the second film and the first film and the second film can then be secured together to form a continuous rectangular-shaped label sheet using nip rolls. Once the first film and the second film are laminated by the nip rolls, label graphics and information can be added to the label at the printing stations. After the labels are printed, the label sheet is placed into an oven for curing of the label sheet. The label sheet is then passed through embossing rollers to apply the texturing for improving the adhesion characteristics of the label. Finally, the labels are cut to size from the label sheet for application of the adhesive to the labels and placement of the labels onto containers.

Chemically Etching Label Film to Enhance Adhesion

In another example, the label film can be chemically etched to improve the adhesion properties of the label. For example, to chemically etch the label, an acid could be applied to the clear film forming the label. Any type of acid that may have a number of different chemistries may be suitable for etching the label material. Also many different patterns may be applied to the label to improve the adhesion properties, and the chemical etching could potentially be done in-line in the lamination step or the post-lamination step. In one example, the etching chemical could be simply brushed onto an inner surface of the label. The chemical may then react with the material forming the label to provide texturing, such as, pockets, holes, or grooves in the material to improve the adhesion of the label to the container. It is also contemplated that the chemical etching may also be applied to a container (in which case the acid could have similar effect in applying a texturing to the container surface). Furthermore, if desired, the etching could potentially be applied on only the overlap area of the label or where adhesion is most critical to secure the label to the container.

The chemical etching process can have a similar effect as the embossing process in applying texturing to the label to increase the surface energy and adhesion of the label. Chemical etching like embossing promotes the adhesion properties of the clear film or label material by providing the clear film with a rougher surface or pockets, grooves, or holes to increase the surface energy and thus the bond between the label and the container.

An exemplary etching process is shown in FIG. 5. As shown in FIG. 5, again the label sheet can be formed of a first film and a second film. An adhesive can be applied to the first film before the first film and the second film are placed between nip rollers to laminate the first film and the second film together to form the label sheet. A resistive coating can then be applied to the label sheet, and the label sheet can then be placed into an oven to cure the label sheet. The label sheet can then be placed into an etching bath where the label receives an etching chemical to provide texturing onto the label for improving the adhesion properties of the label. The label graphics and information can then be added at a printing step where multiple inks are added to the label in the desired patterns and formations. The label is then cured again in an oven to ensure that the inks are dried. Finally the label sheet is finished, and the label sheet is cut to form individual labels for placement onto the container.

Application of UV Radiation to Clear Film

In another example, UV radiation can be applied to the clear film forming the label which also promotes the adhesion properties of the film by increasing the surface energy. During the UV radiation process, the film forming the label is exposed to a UV light source. For example, various UV light sources can be provided that may be in the range of approximately 250 to 400 nm. Again this process could be done in-line in the lamination step or in the post-lamination step. UV radiation may also help in improving the adhesion of the film surface in chemically altering the clear label material to increase the surface energy of the surface of the label and subsequently the bond between the film and the container and/or itself at the overlapping portion of the label. The addition of a UV radiation process may be very simple to install in the label forming process. For example, the UV light source could be directed at the manufacturing line such that the label is exposed to the UV light source during the formation of the label or down the production line after the label material is formed.

Application of EVA Heat Seal Coating for Improved Label Flagging Resistance

In another example, the addition of a solvent-based EVA heat seal coating or primer to a label may also significantly improve the adhesion of the label to the container. In this example, adhesion to the label can be enhanced by applying a solvent-based EVA heat seal coating or primer to the film. Also, the EVA heat seal coating could be applied to all of the surfaces of the label or the EVA heat seal may only be applied to the an area where the glue is applied.

The EVA heat seal can also be applied after the label is formed. Alternatively, the EVA heat seal can be applied during the printing process, where the label graphics and information are placed onto the label. In one example, a solvent-based primer or EVA heat seal can be applied to both sides of the label to improve its adhesion characteristics. Applying the EVA heat seal can also be done in conjunction with the texturing techniques described herein to enhance the adhesion properties of the label.

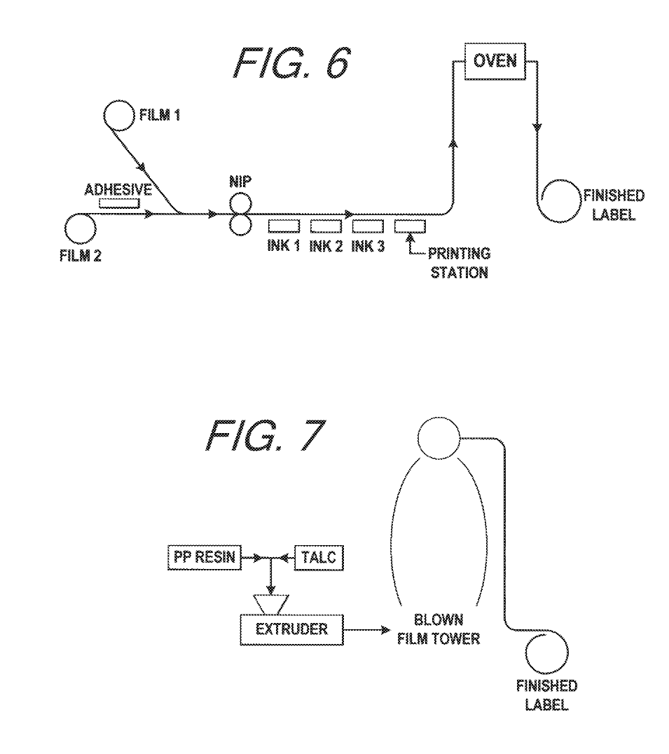

FIG. 6 depicts an example EVA heat seal coating process. Similar to the embossing and chemical etching processes above, the label sheet can be formed of a first film and a second film. The first film and the second film can be laminated together using adhesives and nip rollers. After the label sheet is laminated, the label graphics and product information can be added to the label sheet. Next in accordance with the above, an EVA heat seal coating or primer can be applied after or as the label is printed onto the label to improve the adhesion properties of the label. The EVA heat seal coating can be added at the primer station. After the EVA coating step, the label can then be cured by an oven, and the label can be finished and cut to the appropriate size for securing the label to a container.

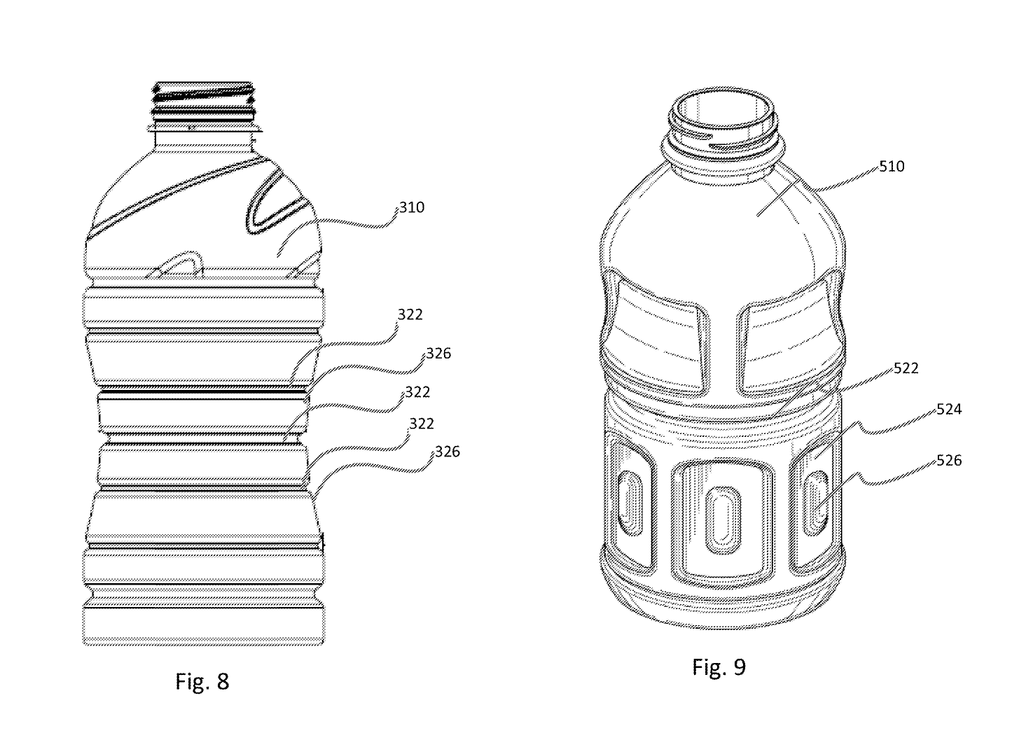

The examples discussed herein can be used on a variety of container types. For example, the methods and examples discussed herein may help to adhere and maintain labels to complicated container geometries, such as containers having various vacuum panels, ribs, and contours where labels have limited surface area to adhere to the container. For example, as shown in FIG. 8, a container 310 may include various contours 326 and ribs 322 where the label is applied. Also, as shown in FIG. 9, container 510 can include vacuum panels 524, projections 526, and ribs 522. The labels discussed herein may adhere better to these types of containers having complex geometries and limited surface area.

One example method of applying a label to a container having a complex geometry is to heat shrink the label onto the container. In one example, the label can be rolled onto the container and then inserted into a shrink tunnel where the label is heated which causes the label or film to shrink and bond to the container. Thus, in shrink tunnel applications, the label is heated after it is applied to the container. A higher strength, higher molecular weight adhesive may provide increased heat resistance in shrink tunnel applications and may not bond adequately to a container. Also more heat resistant adhesives tend to be less likely to adhere to polypropylene, a common material for forming containers. However, the methods and examples discussed herein when used with a lower strength/lower molecular weight adhesives or without adhesives can maintain the label adequately on the container. Nonetheless, it is contemplated that a higher molecular weight, heat resistant adhesive can be used in conjunction with the examples discussed herein.

Additionally, handling, shipping, and environmental changes can lead to label flagging or peeling failures. For example, handling, shipping, and environmental changes may cause temperature and pressure changes to the contents and generally more shock, stress and strain on the adhesive bond of the label to the container and may lead to the label separating from the container. The examples and methods discussed herein may be useful in preventing such failures. In particular, the examples and methods discussed herein may be helpful in ensuring that labels remain secured to their respective containers during pressure changes due to shipping and environmental changes. However, the examples discussed herein can have applicability in many different applications and are not limited to the particular examples discussed herein.

Testing was conducted to determine whether the EVA heat seal coating improved label performance. During the testing, sample films were heat sealed with measured amounts of label adhesive between them. Weights were placed on the labels, and the labels were stored in a room at elevated (120 F) temperature to mimic the process that is observed when containers expand due to heat. In one test, an elevated temperature lap shear test was conducted to mimic the abuse failure found in carbonated soft-drink labels. Shear stress was observed in the position of the overlap on the container. The time required for the label sample to fail was recorded for each of the label samples. This test was devised to evaluate the failure mode observed in the transportation of carbonated beverages, where elevated temperatures stress the adhesive and cause the bottle to expand, providing an increasing creeping stress on the film to film overlap bond.

The test evaluated opaque films, a clear films, and metalized films. The opaque films included: Film A: 400WT/LII (120 ga, cavitated film)/ adhesive/ 48CTL (48 ga), a polyethylene/polypropylene coextruded film, including TiO₂; and Film B: 28LLG202 (120 ga, cavitated film))/ adhesive/ 612LLG (50 ga) formed of polypropylene. The clear films tested included Film C: 75CTL (75 ga)/adhesive/75CTL (75 ga) and Film D: 19LLG101 (75 ga) /adhesive/ 19LLG101 (75 ga). The metalized films included: Film E, which is a 350WTML metalized film and an unidentified Film F.

It was generally observed that the opaque films (Films A and B) performed better than the clear films (Films C and D). This has also been observed in the field. Film C was the worst performer. Reasons for these differences could include differences in the polypropylene or slip additives used or the potential beneficial effects from the presence of cavitated films used for the opaque films. For example, it is possible that the cavitated films have less slip additives and/or retard the migration of slip additives to the film surface. It was also observed that corona treatment may improve the performance of labels.

As shown below in Table I, the surface energy was also measured for Films A-C which agreed with the static shear results. These evaluations were done prior to the static shear testing, and were not the exact lots of material used for the static shear testing. The below table shows the surface energy values for both the outer surface of the label and the inner surface of the label. The outer surface of the label surface energy value was measured to determine how well the label secures to itself at the overlap portion. In one example, the label can have a surface energy value at the outer surface of the label of approximately equal to or greater than 30 dynes and a surface energy value at the inner surface of the label of approximately equal to or greater than 35 dynes.

TABLE I

| | Outer Surface of Label | Inner Surface of Label |
|---|---|---|
| Film A | 32 dynes | 40 dynes |
| Film B | 34 dynes | 40 dynes |
| Film C | 32 dynes | 32 dynes |

Additionally, surface energy readings on each side of the free films (non-laminated) were recorded. Results are shown below in Table II with each side of a film's dynes reading shown with its position in the structure.

TABLE II

| | |
|---|---|
| Film A | (38-40 dynes) 400WT/LII (120 ga, cavitated film) |
| | (40-42 dynes)/adhesive/(34-40 dynes)48CTL(34-40 dynes) |
| Film B | (38-40 dynes) 28LLG202 (120 ga, cavitated film)(38-40 dynes)/ |
| | adhesive/(44-48 dynes) 612LLG (38-42 dynes) |
| Film C | (34-40 dynes) 75CTL (34-40 dynes)/adhesive/(34-40 dynes) |
| | 75CTL(34-40 dynes) |
| Film D | (38-40 dynes) 19LLG101)(40-42 dynes/adhesive/(40-42 dynes) |
| | 19LLG101 (38-40 dynes) |
| Film E | Metalized side: (36-40), opposite side: (40-42) |
| Film F | Metalized side: (34), opposite side: (40-42) |

During the testing, the clear samples (Films C and D) demonstrated a slightly lower amount surface energy than the opaque samples (Films A and B) on the side of the film placed against the label adhesive. Opaque sample, Film B, generally had higher dynes ranges than the other opaque sample, Film A. However, there is an overlap and not a clear break between each of the films in dynes readings.

It is also contemplated that a mineral could be added to the mixture forming the label to increase the adhesion properties of the label. In this example, a mineral can be added to the material forming the clear label when the mixture is formed. For example, a talc-based mineral could be added to the mixture. The mineral can add a certain texture to the label to promote the adhesiveness of the label and, thus, the securement of the label to the container.

Additionally, the clear films performed better when a solvent-based primer is added. A water-based primer was also tested where no performance benefits were observed. This may demonstrate the importance of surface compatibility between the primer and the film. In particular, in one test, a sample using a clear AET laminate with no coating, a sample of a clear AET laminate with a water-based, EVA coating, and a sample of a clear AET laminate with the solvent-based EVA coating were tested. The test illustrated that the sample without coating and the water-based EVA coated sample had poor adhesion properties, but the same material with a solvent-based EVA coating improved the performance dramatically, thus proving that the right surface properties may improve adhesion significantly.

FIG. 7 shows an example of a process where a label sheet can be formed with a mineral to improve the adhesive properties of the labels. In this example, the label sheet can be formed with a polypropylene resin and talc. The polypropylene resin can be mixed with the talc in an extruder. Polypropylene film embedded with talc can then be extruded into a blown film.

It is also contemplated that different materials such as different polypropylenes, polyethylenes, and/or additives can be used to provide improved adhesion on the label surfaces. In addition, less crystalline and lower molecular weight resins could improve adhesion and may provide better wetting for a given adhesive. Less or different slip additives could also be added to improve adhesion.

In one example, a method of forming a label is provided. The method comprises extruding at least one layer of film to form the label, forming a texture on the label, and securing the label to a container with an adhesive. The texture may improve the adhesion of the label to the container.

In one example, the texture can be formed onto the label by embossing. The embossing can be provided to the label with two embossing wheels on both a first surface and a second surface of the label. The texturing can be applied as the label is extruded or the texturing can be applied after the label is extruded. In another example, the texturing of the label can be provided by chemically etching the texture onto the label. An acid may be used to chemically etch the label, and the acid may be coated onto a surface of a label. In another example, increased adhesion can be achieved by chemically increasing the surface energy by exposing the label to UV radiation. In yet another example, the texturing may be provided onto the label by adding a mineral to the mixture forming the label.

In another example, a method of forming a label for improved adhesion to a container can include extruding at least one layer of film to form the label, applying an EVA heat seal to the label, and securing the label to a container with an adhesive. The EVA heat seal can improve the adhesion of the label to the container. The EVA heat seal can be applied as the label is extruded, or the EVA heat seal can be applied after the label is extruded. A first surface and a second surface of the label can be provided with the EVA heat seal.

In another example, a method of forming a label for a container may include one or more of the following steps: extruding at least a first layer to form the label in a rectangular shape, the label can include a first surface and a second surface, an overlapping portion configured to secure to one of a first end or a second end of the label to connect the first surface to the second surface, applying a resistive coating to the label, adding graphics to the label at a printing station, placing the label into an oven for curing, forming a texture on the label to increase surface energy for improving adhesion properties of the label and for securing the label to a container with an adhesive. The surface energy of the first surface and second surface may be approximately 30 or more dynes. In the example method the texture can be formed onto the label by embossing and the embossing can occur with two embossing wheels. The embossing can be formed of one of a dimpled, X, circular, diamond, square, or rhombus shape. The first surface and the second surface of the label can be provided with the texture. In the example method, the texture can applied as the label is extruded or the texture can be applied after the label is extruded. In one example, the texture of the label can be provided by chemically etching where an acid is used to chemically etch the texture onto the label. In another example, the texture can be provided onto the label by exposing the label to UV radiation, and the UV radiation can be approximately 250 to 400 nm. The texture can be provided onto the label by adding a mineral to the extruded first layer, and the mineral can be a talc. The texture can be applied to predetermined selected critical portions of the label.

In another example, a method may include one or more of the following steps: forming a continuous sheet using a first film and a second film and securing the first film to the second film together using an adhesive in a lamination operation, the continuous sheet may include a first surface and a second surface, adding graphics to the continuous sheet at a printing station, placing the continuous sheet into an oven for curing, adding a texture or primer to the sheet, and cutting the continuous sheet into a plurality of labels. A surface energy of the first surface and the second surface can be approximately 30 or more dynes. A texture can be applied to the sheet and the texture can be provided onto the sheet by exposing the sheet to UV radiation, by adding a mineral to either the first film or the second film, or by embossing. The label can be applied to a container in a shrink tunnel.

In another example, a method of forming a label may include one or more of the following steps: extruding at least one layer to form the label in a rectangular shape, the label comprising an overlapping portion for securing the label to a container, and applying a primer to the label. The primer may improve the adhesion of the label to the container when securing the label to a container with an adhesive. The primer can be an EVA heat seal coating. The primer can be applied after the label is extruded or as printing is added to the label. A first surface and a second surface of the label can be provided with the primer.

In another example, a label for a container may include a rectangular strip having a first surface and a second surface, a first end and a second end, an overlapping portion configured to secure to one of a first end or a second end of the strip, a resistive coating, one or more graphics, a texture or primer formed on the first surface of the strip to increase surface energy and for improving adhesion properties of the strip for securing the strip to a container with an adhesive. A texture is applied to the first surface of the strip, and the texture can be formed onto the strip by one of embossing, chemically etching, UV radiation, or by adding a mineral to a mixture forming the strip. The surface energy of the first surface of the strip can be approximately 30 or more dynes. The second surface of the strip can include the texture and the texture can be formed of one of dimpling, X, circular, diamond, square, or rhombus shapes. In one example, the texture can be applied to predetermined selected critical portions of the strip.

In another example, a container may include a top portion, an elongated plastic outer surface, a cap removably attachable to the top portion of the container to enclose a liquid contained therein, a base structure, and a rectangular label secured to the elongated plastic outer surface of the container with an adhesive. The label may include a first surface and a second surface, a first end and a second end, an overlapping portion configured to secure to one of a first end or a second end of the label, a resistive coating, one or more graphics, and a texture or primer formed on the first surface of the label. The texture or primer may help to increase surface energy and may help to improve adhesion properties of the label when securing the label to the container with an adhesive.

In another example, a texture may be applied to the first surface of the label and the texture can be formed onto the label by one of embossing, chemically etching, or UV radiation. The texture can be formed of one of dimpling, X, circular, diamond, square, or rhombus shapes. The texture can be provided onto the label by adding a mineral to a mixture forming the label. The texture can be applied to predetermined selected critical portions of the label. The surface energy of the first surface of the label can be approximately 30 or more dynes. The second surface of the label may include the texture.

Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention.

What is claimed is:

1. A label for a container comprising:
a rectangular strip having a first surface and a second surface, a first end and a second end;
an overlapping portion configured to secure to one of a first end or a second end of the strip;
a resistive coating;
one or more graphics;
a texture or primer placed on the first surface of the strip to increase surface energy and for improving adhesion properties of the strip for securing the strip to a container with an adhesive.

2. The label of claim 1 wherein a texture is applied to the first surface of the strip and the texture is formed onto the strip by one of embossing, chemically etching, or UV radiation.

3. The label of claim 1 wherein the surface energy of the first surface of the strip is approximately 30 or more dynes.

4. The label of claim 2 wherein the second surface of the strip includes the texture.

5. The label of claim 2 wherein the texture is formed of one of dimpling, X, circular, diamond, square, or rhombus shapes.

6. The label of claim 1 wherein a texture is applied to the first surface of the strip and the texture is provided onto the strip by adding a mineral to a mixture forming the strip.

7. The label of claim 1 wherein a texture is applied to the first surface of the strip and the texture is applied to predetermined selected critical portions of the strip.

8. A method of forming a label for a container comprising:
extruding at least a first layer to form the label in a rectangular shape, the label comprising a first surface and a second surface, an overlapping portion configured to secure to one of a first end or a second end of the label to connect the first surface to the second surface;
applying a resistive coating to the label;
adding graphics to the label at a printing station;
placing the label into an oven for curing; and
forming a texture on the label to increase surface energy for improving adhesion properties of the label and for securing the label to a container with an adhesive;
wherein the surface energy of the first surface and second surface is approximately 30 or more dynes.

9. The method of claim 8 wherein the texture is formed onto the label by embossing.

10. The method of claim 9 further comprising embossing the label with two embossing wheels.

11. The method of claim 9 wherein the first surface and the second surface of the label are provided with the texture.

12. The method of claim 9 wherein the embossing is formed of one of a dimpled, X, circular, diamond, square, or rhombus shape.

13. The method of claim 8 wherein the texture is applied as the label is extruded.

14. The method of claim 8 wherein the texture is applied after the label is extruded.

15. The method of claim 8 wherein the texture of the label is provided by chemically etching.

16. The method of claim 8 wherein an acid is used to chemically etch the texture onto the label.

17. The method of claim 8 wherein the texture is provided onto the label by exposing the label to UV radiation.

18. The method of claim 17 wherein the UV radiation is approximately 250 to 400 nm.

19. The method of claim 8 wherein the texture is provided onto the label by adding a mineral to the extruded first layer.

20. The method of claim 19 wherein the mineral is a talc.

21. The method of claim 8 wherein the texture is applied to predetermined selected critical portions of the label.

22. A method comprising:
forming a continuous sheet using a first film and a second film and securing the first film to the second film together using an adhesive in a lamination operation, the continuous sheet comprising a first surface and a second surface;
adding a texture or primer to the continuous sheet;
adding graphics to the continuous sheet at a printing station;
placing the continuous sheet into an oven for curing; and
cutting the continuous sheet into a plurality of labels;
wherein a surface energy of the first surface and the second surface is approximately 30 or more dynes.

23. The method of claim 22 wherein a texture is applied to the sheet and the texture is provided onto the sheet by exposing the sheet to UV radiation.

24. The method of claim 22 wherein a texture is applied to the sheet and the texture is provided onto the sheet by adding a mineral to either the first film or the second film.

25. The method of claim 22 wherein a texture is applied to the sheet and the texture is formed onto the sheet by embossing.

26. The method of claim 22 wherein the plurality of labels are applied to a container in a shrink tunnel.

27. A method of forming a label comprising:
extruding at least one layer to form the label in a rectangular shape, the label comprising an overlapping portion for securing the label to a container; and
applying a primer to the label;
wherein the primer helps improve adhesion of the label to the container when securing the label to a container with an adhesive.

28. The method of claim 27 wherein the primer is an EVA heat seal coating.

29. The method of claim 27 wherein the primer is applied after the label is extruded.

30. The method of claim 27 wherein the primer is applied as printing is added to the label.

31. The method of claim 27 wherein a first surface and a second surface of the label are provided with the primer.

32. A container comprising:
a top portion;
an elongated plastic outer surface;
a cap removably attachable to the top portion of the container to enclose a liquid contained therein;
a base structure; and
a rectangular label secured to the elongated plastic outer surface of the container with an adhesive, the label having a first surface and a second surface, a first end and a second end, an overlapping portion configured to secure to one of a first end or a second end of the label, a resistive coating, one or more graphics, and a texture or primer formed on the first surface of the label;
wherein the texture or primer helps to increase surface energy and helps to improve adhesion properties of the label when securing the label to the container with an adhesive.

33. The container of claim 32 wherein a texture is applied to the first surface of the label and the texture is formed onto the label by one of embossing, chemically etching, or UV radiation.

34. The container of claim 32 wherein the surface energy of the first surface of the label is approximately 30 or more dynes.

35. The container of claim 33 wherein the second surface of the label includes the texture.

36. The container of claim 33 wherein the texture is formed of one of dimpling, X, circular, diamond, square, or rhombus shapes.

37. The container of claim 32 wherein a texture is applied to the first surface of the label and the texture is provided onto the label by adding a mineral to a mixture forming the label.

38. The container of claim 32 wherein a texture is applied to the first surface of the label and the texture is applied to predetermined selected critical portions of the label.
